(19) United States
(12) Patent Application Publication
(10) Pub. No.: US 2005/0220004 A1
(43) Pub. Date: Oct. 6, 2005

(54) Repeater for power line communication system

(75) Inventors: Thomas Vollmer, Aachen (DE); Thomas Durbaum, Langerwehe (DE); Carsten Deppe, Aachen (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/506,837

(22) PCT Filed: Mar. 3, 2003
(86) PCT No.: PCT/IB03/00873

§ 371 Date: Sep. 7, 2004

(30) Foreign Application Priority Data
Mar. 12, 2002 (DE) 102 10 858.7

(51) Int. Cl. H04J 7/00

(52) U.S. Cl. 370/212

(57) ABSTRACT

The invention relates to a method and a device (1) for data transmission in a power supply network (power line communication). The device (1), preferably centrally located in a distribution box (6), is equipped with transceivers (3, 4, 5), each one of which is connected to a phasing line (11, 12, 13) of the power supply network, from which it can receive data, and to which it can transmit data. The transceivers are coupled via a control unit (2), wherein the control unit ensures that the data received from a phasing line can be transmitted, prepared, on at least one other phasing line. Hereby, a re-transmission on all phasing lines with the same transmission power, or a re-transmission matched to the particular signal strengths or the addressees of the data, can take place.

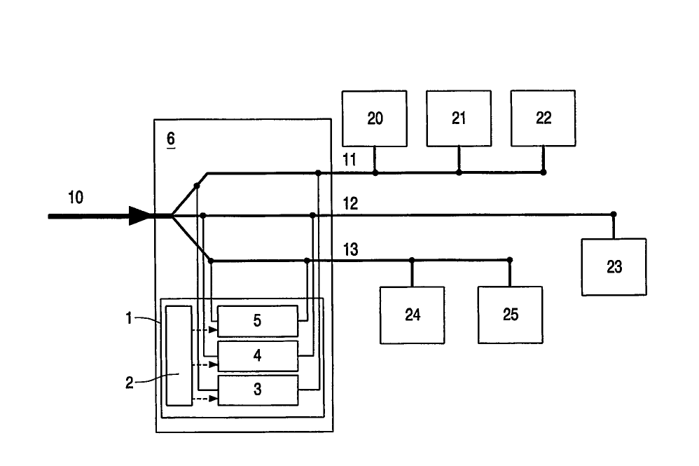

The invention relates to a method and a device for data transmission in a power supply network.

The designation “Power Line Communication” (PLC) relates to a known method by which data is transmitted via the electrical lines of a power supply network which is intended per se for the supply of electricity. The advantage of a power line communication of this kind lies in the fact that, in more or less every household, lines belonging to the power supply network are present in virtually every room, making it possible to cross-link appliances in different rooms without the need for rewiring. Whilst, in this respect, by virtue of outdated statutory provisions, only small frequency ranges have hitherto been permitted on power supply lines for the transmission of signals, these restrictions will be lifted in the future, making data rates of more than 10 Mbit/s possible. Power line communication can be used here both as a main infeed in the sense of a “last mile” for infeeding the Internet via the power supply network, and also in setting up an in-home network. Using the high data rates referred to, it would, for example, be possible to send the signal from a video recorder from the living room directly to a television in a different room without additional cables.

However, the use of power supply lines for data communication encounters a number of technical difficulties, such as:
high attenuation as a result of detours of the line installation (also where sockets are located close together in some cases).
inadequate transmission between different phasing lines of the power supply network. According to the prior art, passive phase couplers are used in the distribution box for transmission between different phasing lines, as a result of which, however, the transmission power is distributed among the various phasing lines and is thereby reduced.
the existence of numerous interference sources, including, in principle, every electronic appliance.
the low permitted transmission power.

In order to solve some of the problems outlined above, it is known from WO 00/21212 for repeaters to be arranged, spaced apart from one another, along a phasing line of a power supply network, which repeaters can receive the data signal transmitted on the phasing line by means of a receiver, decode it and subsequently transmit it, amplified, back to the phasing line by means of a transmitter.

Against this background, it was an object of the present invention to provide a method and a device which enable an improvement of power line communication in power supply networks with multiple phasing lines.

This object is achieved by means of a method with the features as claimed in claim 1 and by a device with the features as claimed in claim 6. Advantageous embodiments are described in the dependent claims.

In a method for data transmission in a power supply network in accordance with the invention (so-called power line communication), the data transmitted on a phasing line of the power supply network is received and then re-transmitted. The method is characterized by the fact that the data is re-transmitted on at least one phasing line different from the phasing line from which it was received. The re-transmission of the data preferably takes place at the maximum permitted power.

A method of this kind safeguards the transmission of data between different phasing lines of a power supply network by actively passing on data transmitted on a phasing line to at least one different phasing line. Since, in particular, an amplification of the signals can also take place hereby, a reduction of the maximum attenuation to one half and a tripling of the effective transmission power per phasing line can be achieved with this method. In this manner, the reliability of the power line communication is ensured.

Using this method, the data received from a first phasing line can be re-transmitted on at least one different phasing line and, additionally, on the first phasing line. In this manner, a repeater function is realized on the first phasing line, which repeater function leads to the amplification of a weak signal. In particular, the data received from a first phasing line can subsequently be re-transmitted on all phasing lines of the power supply network using this method, preferably at the maximum permitted transmission power (“standard repeater”). A repetition of this kind of the data, with the same strength on all phasing lines, requires a minimal amount of control.

In accordance with a development of the method, the data may also be re-transmitted only on the phasing lines of the power supply network on which its original signal strength was weak, i.e. lay below a threshold value. In this manner, an “adaptive repeater” can be obtained, which repeats the signal only on the phasing lines on which no reception was yet likely.

In accordance with another development of the method, the data may also be re-transmitted on only the phasing lines of the power supply network to which the addressees of the particular data are connected. In the case of an “intelligent repeater” of this kind, which phasing lines are connected to which appliances must be known, for instance by means of analysis of associated response signals. If one of these appliances is then subsequently addressed by data on a phasing line of the power supply network, this data can specifically be passed on to that phasing line at which the addressee (appliance) is located.

Further, it is advantageous if, with this method, line management is also undertaken, in which data is prepared before being re-transmitted. The preparation may, in particular, comprise channel equalization and channel matching. To this end, recourse is preferably had to a previously undertaken channel analysis.

The invention further relates to a device for data transmission in a power supply network (power line communication), which device comprises a receiver for receiving data transmitted on a first phasing line of the power supply network, and a transmitter for transmitting data on a second phasing line of the power supply network. The device is characterized in that the first and second phasing lines are different. This means that the data transmitted on the first phasing line and received by the receiver can be passed on, with the device, via the transmitter to a different (second) phasing line, so that the device, in the context of the method explained above, brings about a coupling of the different phasing lines.

The device hereby preferably comprises a receiver and a transmitter for each phasing line of the power supply network, wherein all receivers and transmitters are coupled together by a control unit of the device. In this manner it is possible to receive data from any one of the phasing lines and to pass it on to at least any one other phasing line.

The device and/or its control unit may also be set up in such a way that the device can execute a method of the type explained above. This means that it can execute, in particular, the functions of the explained standard repeater, of an adaptive repeater, intelligent repeater and/or line management.

Furthermore, the device may preferably comprise a (bulk) storage device for the temporary storage of data transmitted on the phasing lines of the power supply network. With the aid of this storage device, it is then possible, with appropriate programming of the control unit of the device, for the device to operate centrally to undertake standby functions for all appliances connected to the power supply network, so that these can be completely switched off.

Furthermore, the device may be equipped with additional transmitting and receiving modules, which enable connection and communication with other transmission methods and networks. In this manner, the device can operate as a universal or adaptable coupling module between different transmission networks.

Furthermore, the device may be equipped with an additional network filter in order to improve the separation of an “in-home network” from an “access network”, which, for example, ensures access to the Internet, and thereby to increase the possible data rate in the home. Hereby, a further transmitter and receiver may preferably be integrated on the access side, and selected data may be routed past the filter.

The invention will be further described with reference to an example of an embodiment shown in the drawing, to which, however, the invention is not restricted.

The FIGURE shows schematically the structure of a power line communication with a device in accordance with the invention for coupling different phasing lines.

The upper part of the FIGURE shows an in-home network based on a power line communication, in which various appliances 20-25 are connected to the three phasing lines 11, 12 and 13 of a power supply line 10. These appliances may be, for example, a television 20, a video recorder 21 and a hard disk (HD) video recorder 22 on a first phasing line 11, a PC 23 on a second phasing line 12, and a washing machine 24 and a further appliance 25 on a third phasing line 13. In a configuration of this kind, problems of communication between two appliances (such as the video recorder 21 and the PC 23), which are connected to different phasing lines 11, 12, may occur.

In order to solve this problem, a repeater 1 is connected in accordance with the invention to the phasing lines 11, 12 and 13, wherein the repeater 1 is preferably installed in a central location in the meter box 6 or in a subsidiary distribution box. The only important consideration, however, is that the repeater 1 can be installed in a location at which access exists to all phases of the power supply network that are used in the building or dwelling, such as the cooker connection that is present in virtually every dwelling.

For each of the phasing lines 11, 12, 13, repeater 1 comprises a power line transceiver 3, 4, 5, each of which has a receiver for receiving data from a phasing line, and a transmitter for transmitting data on (the same) phasing line. As shown, transceiver 3 is connected to phasing line 11, transceiver 4 is connected to phasing line 12, and transceiver 5 is connected to phasing line 13.

Furthermore, all three transceivers 3, 4, 5 are coupled to a control unit 2. The control unit 2 may be of various designs in order to realize functions of different complexities. In the simplest case, as a standard repeater, it can uniformly pass the signal, received from one line, e.g. phasing line 11, and prepared, to all phasing lines 11, 12, 13. Conversely, in the case of operation as an adaptive repeater, the prepared signal is passed only to the phasing lines on which the original signal was weak, i.e. where no reception was yet likely. In the case of operation as an intelligent repeater, control unit 2 additionally analyses, on the basis of the associated response signals, to which phasing lines which appliances are connected. The re-transmitted information is then only ever transmitted on the lines at which the particular addressee is located. Finally, in the case of line management, repeater 1 can also simultaneously assume the function of channel analysis and, where this is possible and necessary, of compensation and matching.

The central arrangement of repeater 1 simultaneously solves the problems of attenuation, of phase coupling and of signal-to-noise ratio. By retrofitting existing installations with repeater 1, ultimate reliability and high data rates can be ensured, even in problematic cases.

### LIST OF REFERENCE NUMBERS

1 Repeater in accordance with the invention
2 Control unit
3, 4, 5 Power line transceivers
6 Meter box
10 Power supply line
11, 12, 13 Phasing lines
20 Television
21 Video recorder
22 HD video recorder
23 PC
24 Washing machine
25 Appliance

1. A method for data transmission in a power supply network, wherein data transmitted on a particular phasing line (11) of the power supply network is received and then re-transmitted, characterized in that the data is re-transmitted on at least one phasing line (12, 13) different from the said phasing line (11).

2. A method as claimed in claim 1, characterized in that the data is re-transmitted on all phasing lines (11-13).

3. A method as claimed in claim 1, characterized in that the data is re-transmitted on the phasing lines (11-13) on which its original signal strength lay below a threshold value.

4. A method as claimed in claim 1, characterized in that the data is re-transmitted only on the phasing lines (11-13) to which the addressees (20-25) of the data are connected.

5. A method as claimed in claim 1, characterized in that a preparation, in particular a channel equalization and channel matching, is undertaken before the re-transmission.

6. A device (1) for data transmission in a power supply network, comprising a receiver (3-5) for receiving data transmitted on a first phasing line (11-13) of the power supply network, and a transmitter (3-5) for transmitting data on a second phasing line (12-13) of the power supply network, characterized in that the first and second phasing lines are different.

7. A device as claimed in claim 6, characterized in that it comprises a receiver and a transmitter (3-5) for each phasing line (11-13) of the power supply network, and that all receivers and transmitters are coupled together by a control unit (2).

8. A device as claimed in claim 6, characterized in that it comprises a storage device for the temporary storage of data transmitted on the phasing lines (11-13) of the power supply network.

9. A device as claimed in claim 6, characterized in that it is equipped with additional transmitting and receiving modules for connection to other networks with different transmission methods.

10. A device as claimed in claim 6, characterized in that it is equipped with an additional network filter for separation of an in-home network from an external network, wherein a further transmitter and receiver are preferably integrated on the external side, and selected data is routed past the filter.
